(19) United States
(12) Patent Application Publication
(10) Pub. No.: US 2013/0276980 A1
(43) Pub. Date: Oct. 24, 2013

(54) ESC WITH COOLING BASE

(71) Applicants: Dmitry LUBOMIRSKY, Cupertino, CA (US); Kyle TANTIWONG, San Jose, CA (US)

(72) Inventors: Dmitry LUBOMIRSKY, Cupertino, CA (US); Kyle TANTIWONG, San Jose, CA (US)

(21) Appl. No.: 13/860,479

(22) Filed: Apr. 10, 2013

Related U.S. Application Data
(60) Provisional application No. 61/637,192, filed on Apr. 23, 2012.
(60) Provisional application No. 61/649,827, filed on May 21, 2012.

(51) Int. Cl. H05H 1/00

(52) U.S. Cl. CPC H05H 1/00
USPC 156/345.29; 269/289 R

(57) ABSTRACT

An electrostatic chuck (ESC) with a cooling base for plasma processing chambers, such as a plasma etch chamber. An ESC assembly includes a 2-stage design where a heat transfer fluid inlet (supply) and heat transfer fluid outlet (return) is in a same physical plane. The 2-stage design includes an assembly of a base upon which a ceramic (e.g., AlN) is disposed. The base is disposed over a diffuser which may have hundreds of small holes over the chuck area to provide a uniform distribution of heat transfer fluid. Affixed to the diffuser is a reservoir plate which is to provide a reservoir between the diffuser and the reservoir plate that supplies fluid to the diffuser. Heat transfer fluid returned through the diffuser is passed through the reservoir plate.

### CROSS REFERENCE TO RELATED APPLICATIONS

This application claims the benefit of U.S. Provisional Application No. 61/637,192 filed on Apr. 23, 2012, titled “ESC WITH COOLING BASE,” and U.S. Provisional Application No. 61/649,827 filed on May 21, 2012, titled “ESC WITH COOLING BASE,” the entire contents of which are hereby incorporated by reference in its entirety for all purposes.

### TECHNICAL FIELD

Embodiments of the present invention relate to the microelectronics manufacturing industry and more particularly to temperature controlled chucks for supporting a workpiece during plasma processing.

### BACKGROUND

Power density in plasma processing equipment, such as those designed to perform plasma etching of microelectronic devices and the like, is increasing with the advancement in fabrication techniques. For example, powers of 5 to 10 kilowatts are now in use for plasma etching 300 mm substrates (e.g., semiconductor wafers). With the increased power densities, enhanced cooling of a chuck is beneficial during processing to control the temperature of a workpiece uniformily.

Thermal non-uniformities limit a plasma processing window within which good microelectronic devices yields from the substrate are available. In the art, such non-uniformities are particularly large in the azimuthal direction (e.g., These non-uniformities cannot be sufficiently compensated with other hardware and process tuning and thus ultimately effect on-wafer performance.

### BRIEF DESCRIPTION OF THE DRAWINGS

Embodiments of the present invention are illustrated by way of example, and not limitation, in the figures of the accompanying drawings in which:

FIG. 1 is a schematic of a plasma etch system including a chuck assembly in accordance with an embodiment of the present invention;

FIG. 2 illustrates an exploded isometric view of a cooling base assembly that is employed in the chuck assembly of FIG. 1, in accordance with an embodiment;

FIG. 3A illustrates a cross-sectional isometric view of a cooling base assembly, in accordance with an embodiment;

FIG. 3B illustrates an expanded cross-sectional isometric view of a cooling base assembly, in accordance with an embodiment;

FIG. 4A illustrates a plan view of a top surface of a diffuser that is employed in the cooling base assembly of FIGS. 2, 3A, and 3B, in accordance with an embodiment; and

FIG. 4B illustrates a plan view of a bottom surface of the diffuser illustrated in FIG. 4A, in accordance with an embodiment.

### DETAILED DESCRIPTION

In the following description, numerous details are set forth. It will be apparent, however, to one skilled in the art, that the present invention may be practiced without these specific details. In some instances, well-known methods and devices are shown in block diagram form, rather than in detail, to avoid obscuring the present invention. Reference throughout this specification to “an embodiment” means that a particular feature, structure, function, or characteristic described in connection with the embodiment is included in at least one embodiment of the invention. Thus, the appearances of the phrase “in an embodiment” in various places throughout this specification are not necessarily referring to the same embodiment of the invention. Furthermore, the particular features, structures, functions, or characteristics described herein may be combined in any suitable manner in one or more embodiments. For example, features described in the context of a first embodiment may be combined with features described in a second embodiment anywhere the two embodiments are not mutually exclusive.

The terms “coupled” and “connected,” along with their derivatives, may be used herein to describe structural relationships between components. It should be understood that these terms are not intended as synonyms for each other. Rather, in particular embodiments, “connected” may be used to indicate that two or more elements are in direct physical or electrical contact with each other. “Coupled” my be used to indicated that two or more elements are in either direct or indirect (with other intervening elements between them) physical or electrical contact with each other, and/or that the two or more elements co-operate or interact with each other (e.g., as in a cause an effect relationship). The terms “fluidly coupled” and “fluid communication” refer to structural relationships of elements which allow the passage of a fluid from one of the elements to another. Therefore, first and second elements that are “fluidly coupled” are coupled together in a manner which places the first element in fluid communication with the second element such that fluid in the first element is transferable to the second element, and vice versa, depending on the direction of pressure drop between the elements.

As used in the description of the invention and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items.

The terms “over,” “under,” “between,” and “on” as used herein refer to a relative position of one component or material layer with respect to other components or layers where such physical relationships are noteworthy. For example in the context of material layers, one layer disposed over or under another layer may be directly in contact with the other layer or may have one or more intervening layers. Moreover, one layer disposed between two layers may be directly in contact with the two layers or may have one or more intervening layers. In contrast, a first layer “on” a second layer is in direct contact with that second layer. Similar distinctions are to be made in the context of component assemblies.

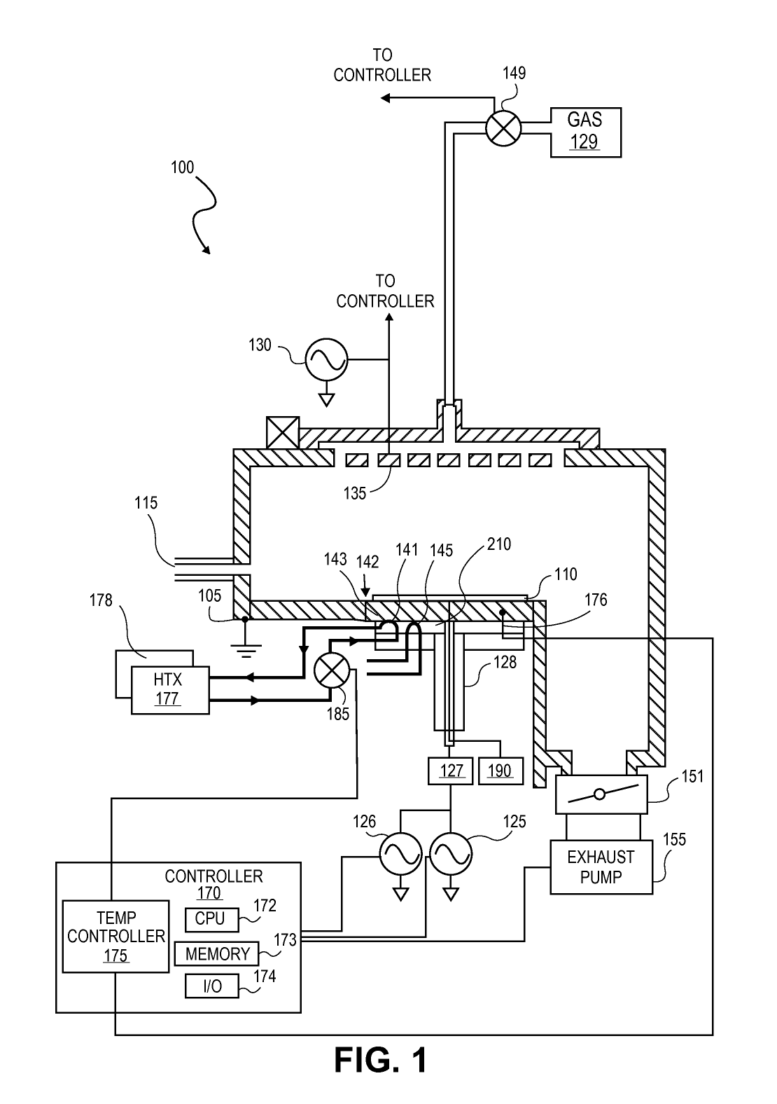

FIG. 1 is a schematic of a plasma etch system 100 including a chuck assembly 142 in accordance with an embodiment of the present invention. The plasma etch system 100 may be any type of high performance etch chamber known in the art, such as, but not limited to, Enabler™, MxP®, MxP+™, Super-E™, DPS II AdvantEdge™ G3, or E-MAX® chambers manufactured by Applied Materials of CA, USA. Other commercially available etch chambers may similarly utilize the chuck assemblies described herein. While the exemplary embodiments are described in the context of the plasma etch system 100, the chuck assembly described herein is also adaptable to other processing systems used to perform any plasma fabrication process (e.g., plasma deposition systems, etc.) that place a heat load on the chuck.

Referring to FIG. 1, the plasma etch system 100 includes a vacuum chamber 105, that is typically grounded. A workpiece 110 is loaded through an opening 115 and clamped to a chuck assembly 142. The workpiece 110 may be any conventionally employed in the plasma processing art (e.g., semiconductor wafer, etc.) and the present invention is not limited in this respect. The workpiece 110 is disposed on a top surface of a dielectric material 143 disposed over a cooling base assembly 210. In particular embodiments, chuck assembly 142 includes a plurality of zones, each zone independently controllable to a setpoint temperature. In the exemplary embodiment, an inner thermal zone is proximate to the center of the workpiece 110 and an outer thermal zone is proximate to the periphery/edge of the workpiece 110. Process (source) gases are supplied from gas source(s) 129 through a mass flow controller 149 to the interior of the chamber 105 (e.g., via a gas showerhead). Chamber 105 is evacuated via an exhaust valve 151 connected to a high capacity vacuum pump stack 155.

When plasma power is applied to the chamber 105, a plasma is formed in a processing region over workpiece 110. A plasma bias power 125 is coupled into the chuck assembly 142 to energize the plasma. The plasma bias power 125 typically has a low frequency between about 2 MHz to 60 MHz, and may be for example in the 13.56 MHz band. In the exemplary embodiment, the plasma etch system 100 includes a second plasma bias power 126 operating at about the 2 MHz band which is connected to the same RF match 127 as plasma bias power 125 and coupled to a lower electrode 120 via a power conduit 128. A plasma source power 130 is coupled through a match (not depicted) to a plasma generating element 135 to provide high frequency source power to inductively or capacitively energize the plasma. The plasma source power 130 may have a higher frequency than the plasma bias power 125, such as between 100 and 180 MHz, and may for example be in the 162 MHz band.

The temperature controller 175 is to execute temperature control algorithms and may be either software or hardware or a combination of both software and hardware. The temperature controller 175 may further comprise a component or module of the system controller 170 responsible for management of the system 100 through a central processing unit 172, memory 173 and input/output interfaces 174. The temperature controller 175 is to output control signals affecting the rate of heat transfer between the chuck assembly 142 and a heat source and/or heat sink external to the plasma chamber 105. In the exemplary embodiment, the temperature controller 175 is coupled to a first heat exchanger (HTX) or chiller 177 and a second heat exchanger or chiller 178 such that the temperature controller 175 may acquire the temperature setpoint of the HTX/chillers 177, 178 and temperature 176 of the chuck assembly, and control a heat transfer fluid flow rate through fluid conduits 141 and 145 in the chuck assembly 142. The heat exchanger/chiller 177 is to cool an outer portion of the chuck assembly 142 via a plurality of outer fluid conduits 141 and the heat exchanger 178 is to cool an inner portion of the chuck assembly 142 via a plurality of inner fluid conduits 145. One or more valves 185 (or other flow control devices) between the heat exchanger/chiller and fluid conduits in the chuck assembly may be controlled by temperature controller 175 to independently control a rate of flow of the heat transfer fluid to each of the plurality of inner and outer fluid conduits 141, 145. In the exemplary embodiment therefore, two heat transfer fluid loops are employed. Any heat transfer fluid known in the art may be used. The heat transfer fluid may comprise any fluid suitable to provide adequate transfer of heat to or from the substrate. For example, the heat transfer fluid may be a gas, such as helium (He), oxygen (O₂), or the like, or a liquid, such as, but not limited to, Galden®, Fluorinert®, or ethylene glycol/water.

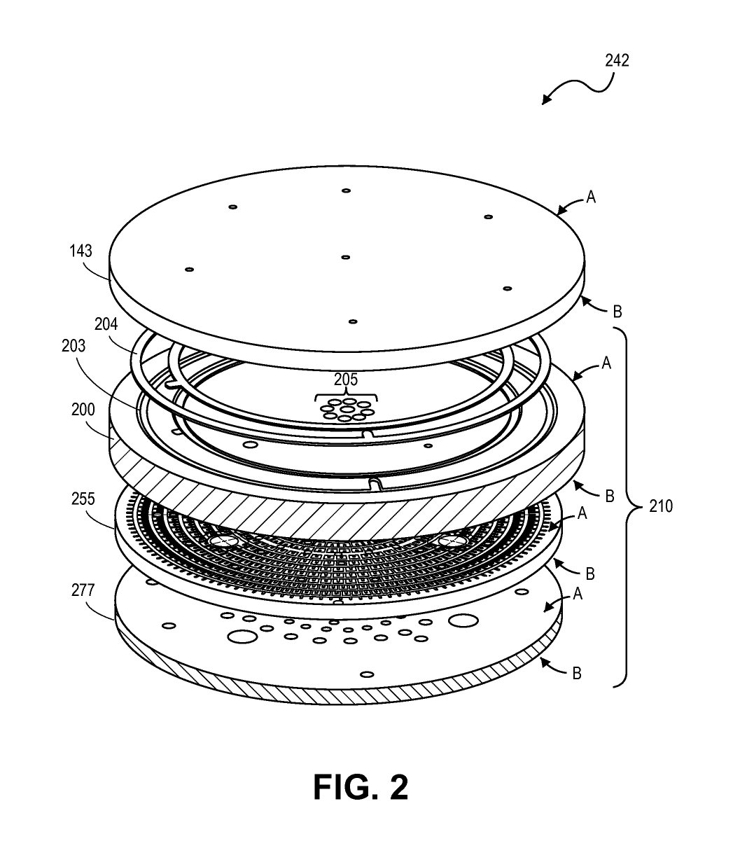

FIG. 2 illustrates an exploded isometric view of an assemble comprising the cooling base assembly 210 employed in the chuck assembly 142, in accordance with an embodiment. In contrast to conventional chucks in use today which employ a serial path for heat transfer fluid (e.g., conduits coiled across a surface of the chuck, the present design is closer in nature to a 2-stage showerhead most often employed for gas delivery in a plasma processing chamber. However, in contrast to conventional gas showerheads, where an inlet/outlet is at opposite ends of the assembly, embodiments of the cooling base assembly 210 have fluid inlets and outlets in a same physical plane (i.e., there is a supply and return at a first interface rather than a single-pass of fluid flow through the assembly). The cooling base assembly 210 includes a base 200 over which a workpiece is to be disposed, a diffuser 255 over which the base 200 is disposed, and a reservoir plate 277 over which the diffuser 255 is disposed. In the exemplary embodiment, the diffuser 255 and base 200 is each a separate plate of a material, preferably the same material (e.g., aluminum) for the sake of matching coefficients of thermal expansion (CTE). The cooling base assembly 210 may be fabricated in multiple steps, with three main parts/components that are joined (e.g., permanently bonded, press fit, or removably attached by screws, etc.) during fabrication to make one complete base.

As illustrated in FIG. 2, each of the base 200, diffuser 255, and reservoir plate 277 have top surfaces A and bottom surfaces B. Disposed over the top surface of the base 200 is the dielectric material 143 upon which the workpiece is to be disposed, as illustrated in FIG. 1. The dielectric material 143 may be any known in the art and is in one advantageous embodiment a ceramic (e.g., AlN) capable of maintaining an electrostatic charge near the top surface to electrostatically clamp the workpiece during processing. Generally, the dielectric material 143 may be operable as any electrostatic chuck (ESC) known in the art, such as, but not limited to a Johnson-Raybeck (JR) chuck. In one exemplary embodiment, the dielectric material 143 comprises a ceramic puck having at least one electrode (e.g., a mesh or grid) embedded in the ceramic and to be coupled to a DC supply (e.g., 190 in FIG. 1) and induce an electrostatic potential between a surface of the ceramic and a workpiece disposed on the surface of the ceramic when the electrode is electrified.

As further shown in FIG. 2, the base 200 has a top surface that is substantially smooth except for helium distribution grooves 203 into which the helium supply rings 204 are seated. The base 200 further includes through holes to accommodate various lift pins, sensor probes (e.g., fiber optic temperature probes, IV probes, etc.), as well as DC electrode and/or resistive heater power supply lines 205. The base 200 is further to function as a thermally conductive mechanical fluid barrier between the dielectric material 143 and the diffuser 255. The base 200 has a bottom surface which may be exposed to a heat transfer fluid passed through the diffuser 255. As heat transfer fluid is contained by the base 200 with no fluid passing to the top surface of the base 200, the base may be considered a cap affixed to a showerhead with the diffuser 255 being a showerhead showering the base 200 with a uniform distribution of heat transfer fluid. Because the heat transfer fluid is of a controlled temperature (e.g., supplied from either of the HTX/chillers 177, 178), a uniform distribution of heat transfer fluid maintains the base 200 at a temperature that is highly uniform across the area of the base 200 and therefore across the area of the dielectric material 143, and in turn the workpiece as it undergoes processing.

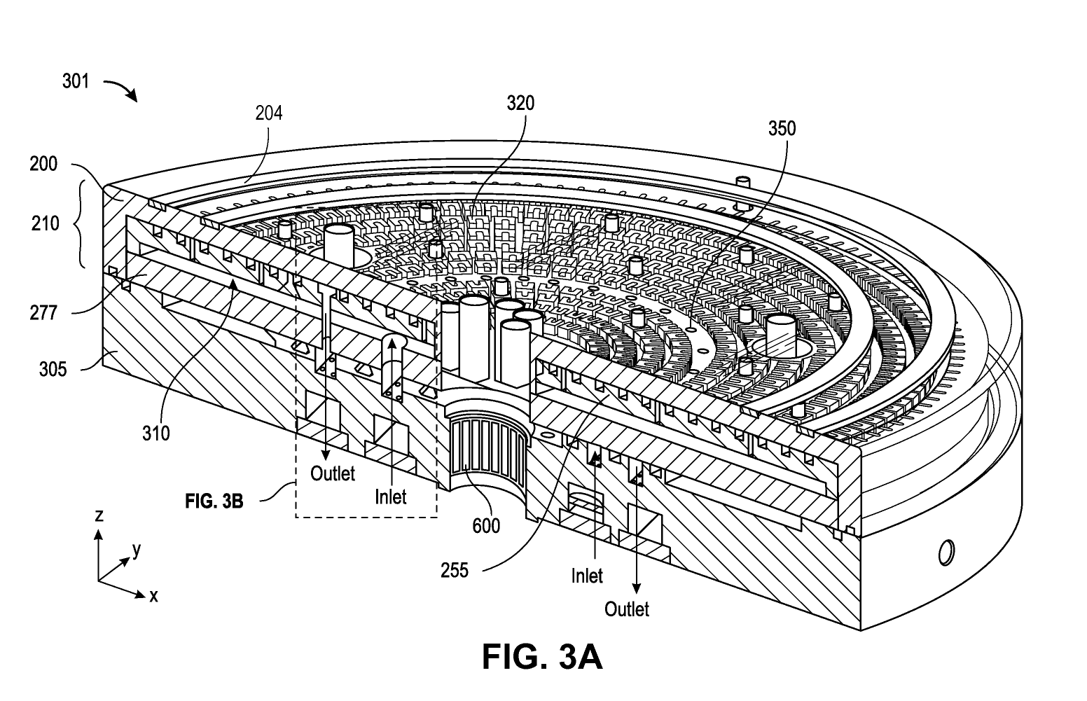

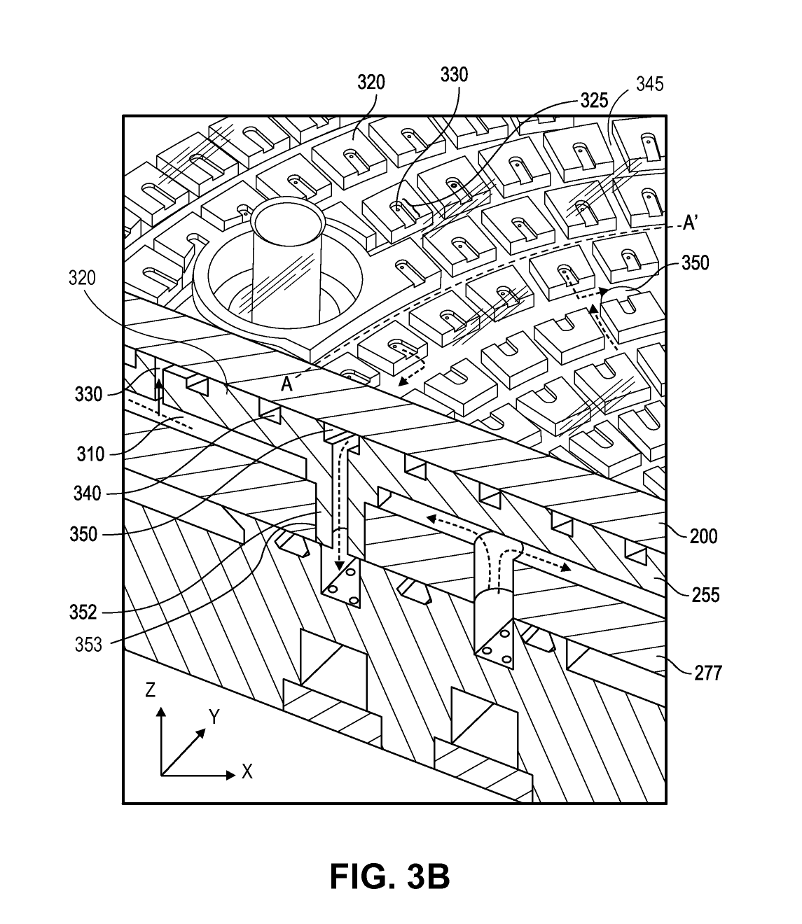

FIG. 3A illustrates a cross-sectional isometric view of the cooling base assembly 301, in accordance with an embodiment. FIG. 3B illustrates an expanded cross-sectional isometric view of the portion of the cooling base assembly 301 outlined in the dashed box in FIG. 3A. In these views, the dielectric material 143 is not present and the base 200 is illustrated as transparent for the sake of depicting the interface of the top surface of the diffuser 255 with the bottom surface of the base 200.

The cooling base assembly 301 includes the cooling base assembly 210 disposed on a support plate 305. The support plate 305 is affixed to the cooling base assembly 210 and includes an RF coupler 600 (e.g., a multi-contact fitting) disposed at a center of the chuck to receive an RF input cable for powering the chuck 142. Heat transfer fluid inlet and outlet fittings are further provided by the support plate 305 as an interface for facilitizing the cooling base assembly 210. In the exemplary embodiment, the support plate 305 is of a same material as the cooling base assembly (e.g., aluminum).

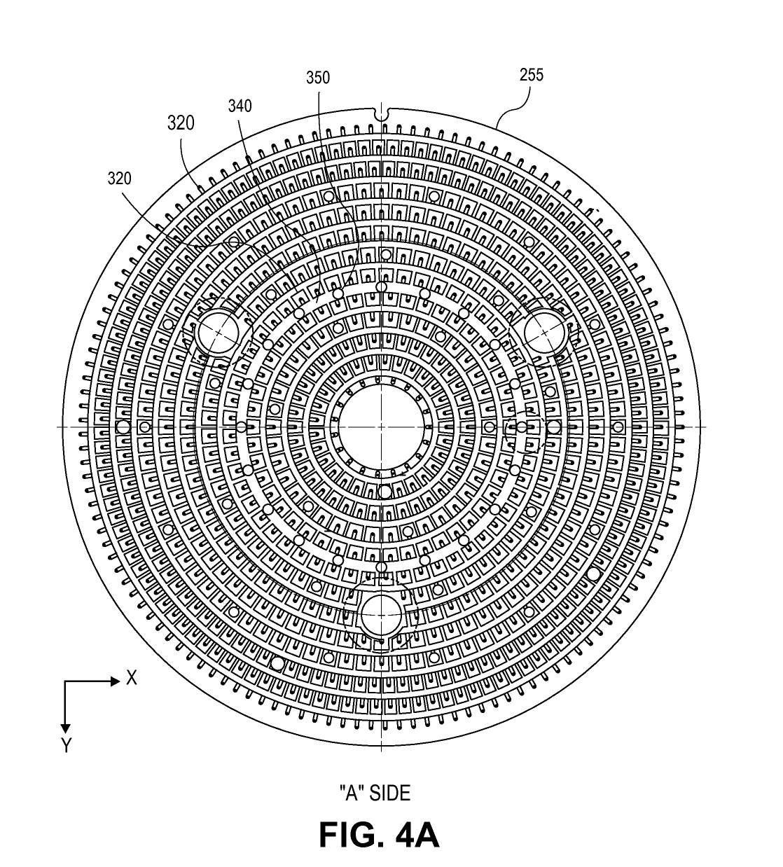

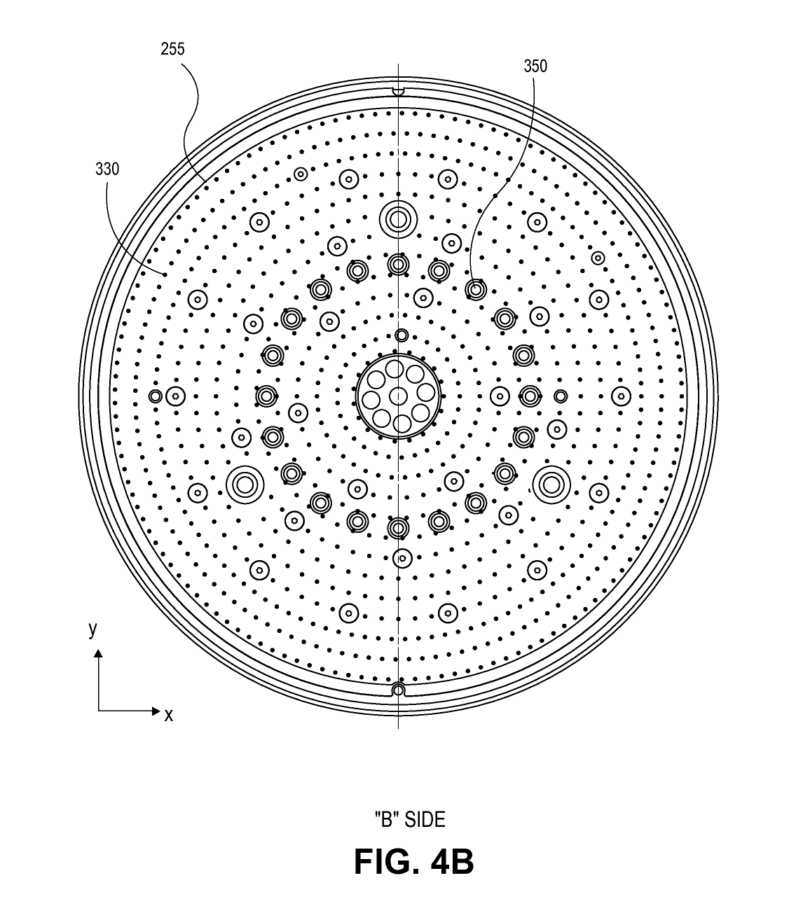

In an embodiment, the diffuser 255 includes a plurality of supply openings 330 that pass through the diffuser 255 and place the bottom surface of the base 200 in fluid communication with a supply reservoir 310 disposed between the diffuser 255 and the reservoir plate 277. The supply openings 330 (i.e., through holes) are illustrated in FIG. 3B, as well as in FIG. 4A, which is a plan view of the top surface (“A-side”) of the diffuser 255, in accordance with an embodiment, and FIG. 4B, which is a plan view of the bottom surface (“B-side”) of the diffuser 255, in accordance with an embodiment. The supply openings 330 are to uniformly distribute heat transfer fluid to the base 200 across the surface area of the base 200. In an advantageous embodiments, there are at least fifty supply openings 330 arranged with azimuthal symmetry about a circular area of the diffuser 255, and in the exemplary embodiment, there are hundreds of the supply openings 330. The azimuthal symmetry, large number of supply openings and wide contiguous area of the underlying supply reservoir 310 work together to provide concentric temperature distributions or boundary conditions. Annual arrangements of heater elements (e.g., resistive) can then be utilized to optimize the radial temperature distribution.

Each supply opening 330 is generally smallest diameter conduit through which the heat transfer fluid is passed, on the order of 10s of mils (where 1 mil is 0.001 inch or 0.00254 millimeter) and in an exemplary embodiments, is between 20 and 100 mil, and preferably between 25 and 75 mil. The small supply openings 330 are to present the majority of the pressure differential in the heat transfer fluid path through the cooling base assembly 210. The supply openings 230 allow for fluid incoming from upstream below the diffuser 255 to build pressure and uniformly flow upward through the diffuser 255. As such, the azimuthal symmetry of the openings ensures azimuthally symmetric heat transfer fluid flow to the base 200. The great number of supply openings 330 ensures a reasonably low pressure pump is sufficient to drive the heat transfer fluid through the coolant loop (e.g., from the HTX/chiller 377, through the supply openings 330, and back).

As shown in FIGS. 3A and 3B, the supply reservoir 310 is an annular cavity having a width in the radial direction that spans a plurality of the annular channels 340. Functionally, the supply reservoir 310 is to provide a low pressure drop across a contiguous area of the reservoir spanning a large percentage of the chuck (base) area so that openings in the diffuser 255 present a uniform pressure differential across the surface area of the diffuser 255. As such, the supply reservoir 310 is upstream of the supply openings 330 with the heat transfer fluid flow path through the supply opening 330 illustrated in FIG. 3B. As illustrated in FIG. 3A, the supply reservoir 310 is provided by a standoff at the outer perimeter of the back surface of the diffuser 255, however the reservoir plate 277 may have a functional equivalent feature to space apart facing surfaces of the diffuser 255 and reservoir plate 277.

In an embodiment, the diffuser 255 includes at least one return opening 350 through which heat transfer fluid is returned through the reservoir plate 277. FIG. 3B illustrates a first return opening 350 in cross-section and a second return opening 350 on the top surface of the diffuser 255. As shown, the return openings pass through the diffuser 255. Aligned with the return opening 350, the diffuser 255 forms a male fitting 352 that seats into a return opening 355 in the reservoir plate 277. The male fitting 352 forms a return conduit that passes though the supply reservoir 310.

In an embodiment, at least a first of the base 200 and the diffuser 255 have a plurality of bosses 320 in physical contact with a second of the base 200 and the diffuser 255. Either a bottom surface of the base 200 or a top surface of the diffuser 255, facing the bottom surface of the base 200, may be machined to have the bosses 320. In the exemplary embodiment, the bosses 320 are machined into the diffuser 255. As shown in both FIGS. 3A and 3B, a top surface of a boss 320 is in direct physical contact with a bottom surface of the base 200.

The bosses 320 further define at least one annular channel between radially adjacent bosses 320. For example, in FIG. 3B, the annular channel 340 has a centerline A-A′ defining a radial distance from the chuck center. In the exemplary embodiment where the plurality of bosses include a boss at many different radial distances (e.g., bosses 320 are visible at 11 discrete radii in FIG. 4A), a plurality of annular channels 340 are defined at discrete radial distances from a center of the chuck with at least one of the bosses 320 disposed between radially adjacent annular channels 340. The annular channels 340 place the plurality of supply openings 330 in fluid communication with at least one return opening 350. Because the bosses 320 are discontinuous along the azimuth angle, the plurality of bosses 320 further define a plurality of radial channels 345 fluidly coupling adjacent annular channels 340. As further shown in FIG. 3B, the supply opening 330 is disposed within a boss 320 with each boss 320 further including a boss channel 325 fluidly coupling the supply opening 330 with an annular channel 340.

In an embodiment, the boss channel 325 is fluidly coupled to channel 340, 345 that is adjacent to a side of the boss 320 that is nearest a return opening. In the exemplary embodiment, the boss channels 325 extend in radial directions so as to fluidly coupled the supply opening with an annular channel 340 adjacent to a side of the boss closest to an annular channel coincident with the plurality of return openings 350. Depending on how many channels 340, 345 contain return openings 350, the boss channels 325 may extend in different directions. For the exemplary embodiment where all return openings 350 are disposed within a single annular channel 340 (permitting closer radio packing of other bosses 320 and permitting relatively straightforward facilitization of fluid return lines, etc.), the boss channels 325 extend radially outward, toward a chuck perimeter, for all bosses at a radial distance inside of the return openings 350 (i.e., at a lesser radial distance) while the boss channels 325 extend radially inward, toward the chuck center, for all bosses 320 at a radial distance outside of the return openings 350 (i.e., at a greater radial distance).

In embodiments, the return openings 350 are disposed in one or more of the annular channels 340, and/or radial channels 345. In the exemplary embodiment, the return openings 350 are disposed in an annular channel 340. As best illustrated by FIGS. 3A, 4A, and 4B, a plurality of return openings 350 are disposed at a same radial distance as one of the annular channels 340 and at different azimuthal angles (e.g., about every 18° in the depicted embodiment).

In embodiments, resistive heaters are embedded in at least one of the dielectric material 143, the base 200, the diffuser 255, the reservoir plate 277, or the support plate 305. In one advantageous embodiment, resistive heaters are embedded in the dielectric material 143. In the exemplary embodiment, a plurality of individual heater zones in the radial direction (e.g., an inner diameter and an outer annulus surrounding the inner diameter) is to compensate for minor radial non-uniformities in temperature that may be present.

It is to be understood that the above description is intended to be illustrative, and not restrictive. For example, while flow diagrams in the figures show a particular order of operations performed by certain embodiments of the invention, it should be understood that such order is not required (e.g., alternative embodiments may perform the operations in a different order, combine certain operations, overlap certain operations, etc.). Furthermore, many other embodiments will be apparent to those of skill in the art upon reading and understanding the above description. Although the present invention has been described with reference to specific exemplary embodiments, it will be recognized that the invention is not limited to the embodiments described, but can be practiced with modification and alteration within the spirit and scope of the appended claims. The scope of the invention should, therefore, be determined with reference to the appended claims, along with the full scope of equivalents to which such claims are entitled.

What is claimed is:

1. A chuck to support a workpiece during plasma processing, the chuck comprising:
a base over which the workpiece is to be disposed;
a diffuser over which the base is to be disposed; and
a reservoir plate over which the diffuser is disposed, wherein the diffuser comprises a plurality of supply openings passing through the diffuser and placing a bottom surface of the base in fluid communication with a supply reservoir disposed between the diffuser and the reservoir plate.

2. The chuck of claim 1, wherein the plurality of supply openings comprises at least fifty openings arranged with azimuthal symmetry about a circular area of the diffuser.

3. The chuck of claim 1, wherein the diffuser further comprises at least one return opening passing through diffuser and coupled with a return conduit that passes through the supply reservoir and with a return opening in the reservoir plate.

4. The chuck of claim 3, wherein at least a first of the base and the diffuser comprises a plurality of bosses in physical contact with a second of the base and the diffuser, wherein the plurality of bosses define at least one annular channel that places the plurality of supply openings in fluid communication with the at least one return opening.

5. The chuck of claim 3, wherein a first of the plurality of supply openings is disposed within a first of the plurality of bosses, and wherein the first of the plurality of bosses further comprises a channel fluidly coupling the supply opening with the at least one annular channel.

6. The chuck of claim 3, wherein the at least one annular channel comprises a plurality of annular channels, each at a radial distance from a center of the chuck with at least one of the bosses disposed between radially adjacent annular channels.

7. The chuck of claim 6, wherein the supply reservoir comprises an annular cavity having a radial width spanning a plurality of the annular channels.

8. The chuck of claim 6, wherein the plurality of bosses further define a plurality of radial channels fluidly coupling adjacent annular channels.

9. The chuck of claim 6, wherein the at least one return opening comprises a plurality of return opening disposed at a same radial distance as one of the annular channels and at different azimuthal angles.

10. The chuck of claim 9, wherein each of the plurality of bosses further comprises a channel fluidly coupling the supply opening with an annular channel adjacent to one of the bosses radially proximate to a return opening.

11. The chuck of claim 10, wherein the plurality of return openings are at a first radial distance from a center of the chuck,
wherein a first of the bosses at a second radial distance from the chuck center, greater than the first radial distance, comprises a channel extending radially from a first supply opening toward the chuck center; and
wherein a second of the bosses at a third radial distance from the chuck center, less than the first radial distance, comprises a channel extending radially from a second supply opening toward the chuck perimeter.

12. The chuck of claim 1, further comprising a ceramic puck disposed over the base, the ceramic puck having at least one electrode embedded therein to induce an electrostatic potential between a surface of the ceramic and the workpiece when the at least one electrode is electrified.

13. The chuck of claim 1, wherein each of the base and diffuser comprise separate plates of a same material and wherein the chuck further comprises a support plate over which the reservoir plate is disposed, wherein the support plate comprises an RF coupler to receive an RF input cable for powering the chuck.

14. The chuck of claim 13, wherein at least one of the ceramic puck, the base, the diffuser, the reservoir plate, or the support plate comprises a plurality of resistive heaters.

15. A chuck to support a workpiece during plasma processing, the chuck comprising:
a support having a top surface over which the workpiece is to be disposed;
a diffuser having a top surface over which the support is to be disposed, wherein the diffuser comprises at least fifty through holes passing through the diffuser and placing a bottom surface of the support in fluid communication with a bottom surface of the diffuser.

16. The chuck of claim 15, further comprising a supply reservoir over which the diffuser is disposed, wherein the supply reservoir spans a contiguous area of the chuck below the plurality of supply openings.

17. The chuck of claim 16, wherein the diffuser further comprises at least one return opening passing through the diffuser and fluidly coupled to a return conduit that passes through the supply reservoir.

18. A plasma etch system comprising:
a vacuum chamber;
a showerhead though which a source gas is supplied to the vacuum chamber;
the chuck of claim 1; and
an RF generator coupled to at least one of the vacuum chamber, showerhead or chuck.

19. The plasma etch system of claim 18, wherein the diffuser plate further comprises at least one return opening passing through diffuser plate and coupled with a return conduit that passes through the supply reservoir; and
wherein the etch system further comprises a heat transfer fluid loop fluidly coupling the supply reservoir to a high pressure side of a heat exchanger or chiller and fluidly coupling the return conduit to a low pressure side of the heat exchanger or chiller.

20. The plasma etch system of claim 19, wherein the heat transfer fluid is a liquid.
